(19) United States
(12) Patent Application Publication
(10) Pub. No.: US 2016/0226804 A1
(43) Pub. Date: Aug. 4, 2016

(54) METHODS, SYSTEMS, AND MEDIA FOR SUGGESTING A LINK TO MEDIA CONTENT

(71) Applicant: Google Inc., Mountain View, CA (US)

(72) Inventors: Courtney Hampson, Mountain View, CA (US); Jason Robert Richard Sanio, Mountain View, CA (US)

(21) Appl. No.: 14/613,040

(22) Filed: Feb. 3, 2015

(51) Int. Cl. H04L 12/58; G06F 3/0484

(52) U.S. Cl. CPC H04L 51/10; G06F 3/04842

(57) ABSTRACT

Methods, systems, and media for suggesting a link to media content are provided. In some embodiments, the method comprises: identifying a plurality of keywords in a message in a communication interface on a user device; determining a plurality of media content items relating to the plurality of keywords; determining a plurality of probability values corresponding to the plurality of media content items, wherein each probability value indicates a likelihood that the message relates to the corresponding media content item; identifying one of the media content items based on the probability values; causing a suggestion to insert a link to the identified media content item to be presented in a suggestion interface on the user device; and in response to determining that the suggestion has been selected on the user device, causing the link to the identified media content item to be inserted in the message in the communication interface.

### TECHNICAL FIELD

The disclosed subject matter relates to methods, systems, and media for suggesting a link to media content.

### BACKGROUND

Users often find media content on video hosting services, social networking services, and other media content sources and want to share it with others. For example, in response to finding a media content item of interest, a user may create a new text message, email message, or an instant message and insert a link to the particular media content item of interest. In another example, the user may locate a sharing interface associated with the media content source to share the media content item of interest. However, it can be difficult and/or time consuming to copy the link from the media content source and paste it into the newly created message. Similarly, it can be difficult and/or time consuming to locate the sharing interface on a page by the media content source, select from multiple applications for sharing the media content item, and then input sharing information, such as an email address of the user's friend or any other suitable identifier of the user's friend.

Accordingly, it is desirable to provide new methods, systems, and media for suggesting a link to media content.

### SUMMARY

Methods, systems, and media for suggesting a link to media content are provided.

In accordance with some embodiments of the disclosed subject matter, a method for suggesting a link to media content is provided, the method comprising: identifying a plurality of keywords in a message in a communication interface on a user device; determining a plurality of media content items relating to the plurality of keywords; determining, using a hardware processor, a plurality of probability values corresponding to the plurality of media content items, wherein each probability value indicates a likelihood that the message relates to the corresponding media content item; identifying one of the media content items based on the probability values; causing a suggestion to insert a link to the identified media content item to be presented in a suggestion interface on the user device; and in response to determining that the suggestion has been selected on the user device, causing the link to the identified media content item to be inserted in the message in the communication interface.

In accordance with some embodiments of the disclosed subject matter, a system for suggesting a link to media content is provided, the system comprising: a hardware processor that is programmed to: identify a plurality of keywords in a message in a communication interface on a user device; determine a plurality of media content items relating to the plurality of keywords; determine a plurality of probability values corresponding to the plurality of media content items, wherein each probability value indicates a likelihood that the message relates to the corresponding media content item; identify one of the media content items based on the probability values; cause a suggestion to insert a link to the identified media content item to be presented in a suggestion interface on the user device; and in response to determining that the suggestion has been selected on the user device, cause the link to the identified media content item to be inserted in the message in the communication interface.

In accordance with some embodiments of the disclosed subject matter, a non-transitory computer-readable medium containing computer-executable instructions that, when executed by a processor, cause the processor to perform a method for suggesting a link to media content, is provided. The method comprises: identifying a plurality of keywords in a message in a communication interface on a user device; determining a plurality of media content items relating to the plurality of keywords; determining a plurality of probability values corresponding to the plurality of media content items, wherein each probability value indicates a likelihood that the message relates to the corresponding media content item; identifying one of the media content items based on the probability values; causing a suggestion to insert a link to the identified media content item to be presented in a suggestion interface on the user device; and in response to determining that the suggestion has been selected on the user device, causing the link to the identified media content item to be inserted in the message in the communication interface.

In accordance with some embodiments of the disclosed subject matter, a system for suggesting a link to media content is provided, the system comprising: means for identifying a plurality of keywords in a message in a communication interface on a user device; means for determining a plurality of media content items relating to the plurality of keywords; means for determining a plurality of probability values corresponding to the plurality of media content items, wherein each probability value indicates a likelihood that the message relates to the corresponding media content item; means for identifying one of the media content items based on the probability values; means for causing a suggestion to insert a link to the identified media content item to be presented in a suggestion interface on the user device; and in response to determining that the suggestion has been selected on the user device, means for causing the link to the identified media content item to be inserted in the message in the communication interface.

In some embodiments, the plurality of keywords includes an indication of a name of an artist, and the plurality of media content items includes one or more media content items associated with the artist.

In some embodiments, the plurality of keywords includes an indication of time, and the plurality of media content items includes one or more media content items corresponding to the indicated time.

In some embodiments, the means for determining the plurality of media content items further comprises means for identifying one or more media content items associated with a user account authenticated on the user device.

In some embodiments, the plurality of probability values are based at least in part on popularity information associated with the corresponding plurality of media content items.

In some embodiments, the plurality of probability values are based at least in part on comments associated with the corresponding plurality of media content items.

In some embodiments, the suggestion interface includes an image associated with the identified media content item.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a schematic diagram of an example of a system for suggesting a link to media content in accordance with some embodiments of the disclosed subject matter.

FIG. 2 shows a detailed example of a user device and a server of FIG. 1 that can be used in accordance with some embodiments of the disclosed subject matter.

FIG. 3 shows an illustrative example of a process for identifying a media content item associated with a message and causing a suggestion to insert a link associated with the media content item to be presented in accordance with some embodiments of the disclosed subject matter.

FIG. 4 shows an illustrative example of a process for selecting a media content item from a group of candidate media content items in accordance with some embodiments of the disclosed subject matter.

FIG. 5 shows an example of a user interface for receiving a message in a communication interface in accordance with some embodiments of the disclosed subject matter.

FIG. 6 shows an illustrative example of a user interface for presenting a suggestion of a link to media content within a message in a communication interface in accordance with some embodiments of the disclosed subject matter.

### DETAILED DESCRIPTION

In accordance with various embodiments, mechanisms (which can include systems, methods, and computer-readable media) for suggesting a link to media content are provided.

In some embodiments, the mechanisms described herein can receive text in a message entered on a user device and can extract keywords from the received text indicating media content related to the message. The mechanisms can then identify a group of candidate media content items based on the keywords, and can select a particular media content item based on a calculated probability value indicating a likelihood that the media content item relates to the message. The mechanisms can then present, on the user device, a suggestion to link to a media content item determined to be related to the keywords in the message. In some embodiments, the suggested link can be inserted in the content of the message, for example, in response to determining that the suggestion has been selected and/or otherwise indicated on the user device.

In some embodiments, candidate media content items and/or the selected media content item can be identified based on information such as how related the extracted keywords are to metadata associated with the media content items, how popular the media content items (e.g., how many times a media content item has been viewed and/or commented on), and/or whether a media content item has been viewed in association with a user account authenticated on the user device on which the message was entered.

In some embodiments, suggestions of links to multiple candidate media content items can be presented on the user device, and a particular media content item can be selected based on user input. Additionally or alternatively, in some embodiments, the particular media content item association with the link suggestion can be selected based on the probability values of the candidate media content items, for example, by selecting the media content item associated with the highest probability value.

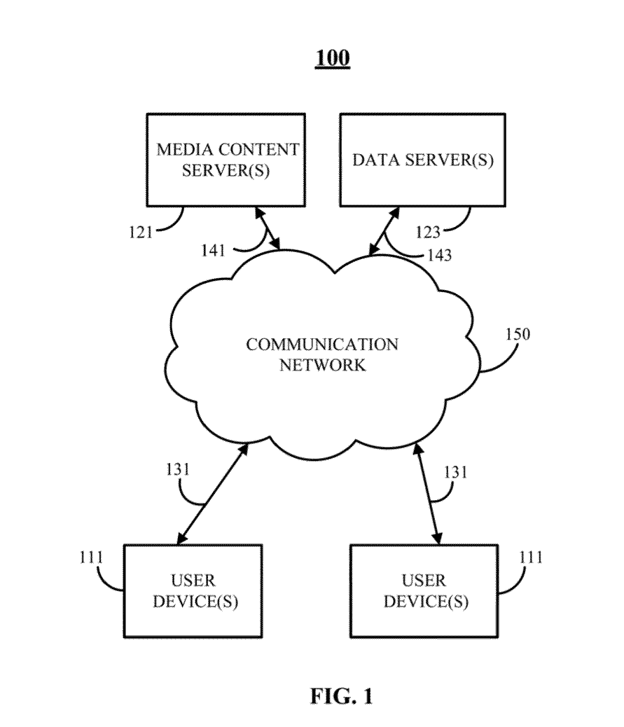

Turning to FIG. 1, an example of a generalized schematic diagram of a system 100 on which the mechanisms for suggesting a link to media content described herein can be implemented is shown in accordance with some embodiments of the disclosed subject matter. As illustrated, in some embodiments, system 100 can include one or more user devices 111, one or more servers 121 and 123, a communication network 150, communication links 131, 141, and 143, and/or other suitable components.

System 100 can include one or more servers, such as media content server(s) 121 and data server(s) 123. Servers 121 and 123 can be any suitable server(s) for providing access to the mechanisms described herein for suggesting a link to media content, such as a processor, a computer, a data processing device, or any suitable combination of such devices. For example, the mechanisms for suggesting a link to media content can be distributed into multiple backend components and multiple frontend components and/or interfaces. As a more particular example, backend components, such as identifying media content items associated with particular keywords can be performed by media content server 121. As another more particular example, backend components, such as determining a probability value indicating a likelihood that a message entered on a user device relates to a particular media content item can be performed by data server 123.

In some embodiments, each of the user devices 111 and server(s) 121 and 123 can be any of a general purpose device such as a computer or a special purpose device such as a client, a server, and/or any other suitable device. Any of these general or special purpose devices can include any suitable components such as a hardware processor (which can be a microprocessor, digital signal processor, a controller, and/or any other type of hardware processor), memory, communication interfaces, display controllers, input devices, and/or any other suitable components. For example, user device 111 can be implemented as a smartphone, a tablet computer, a wearable computer, a personal computer, a laptop computer, a digital media receiver, a personal data assistant (PDA), a set-top box, a smart television, a home entertainment system, a game console, any other suitable user device, or any suitable combination thereof.

Communications network 150 can be any suitable computer network or combination of such networks including the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable type of network. Communications links 131, 141, and 143 can be any communications links suitable for communicating data among user devices 111 and servers 121 and 123, such as network links, dial-up links, wireless links, hard-wired links, any other suitable communications links, or any suitable combination of such links. User devices 111 can enable use of the techniques described herein that can allow the features of the mechanisms to be used. User devices 111 and servers 121 and 123 can be located at any suitable location.

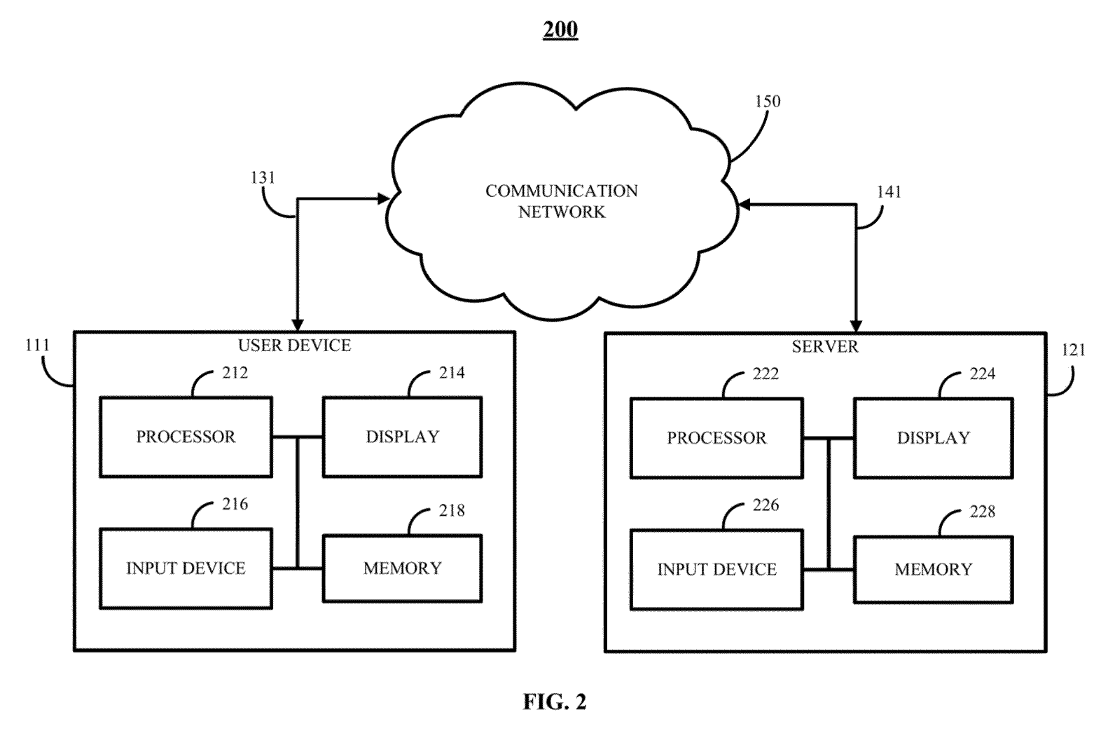

FIG. 2 illustrates an example 200 of hardware that can be used to implement a server, such as servers 121 and/or 123 and one of user devices 111 depicted in FIG. 1 in accordance with some embodiments. Referring to FIG. 2, user device 111 can include a hardware processor 212, a display 214, an input device 216, and memory 218, which can be interconnected. In some embodiments, memory 218 can include a storage device (such as a non-transitory computer-readable medium) for storing a computer program for controlling hardware processor 212.

Hardware processor 212 can use the computer program to present on display 214 content and/or an interface that allows a user to interact with the mechanisms described herein for suggesting a link to media content and to send and receive data through communications link 131. For example, hardware processor 212 can be programmed to extract keywords in a message input on user device 111, present a suggestion of a link to media content, and/or perform any other suitable functions. It should also be noted that data received through communications link 131 or any other communications links can be received from any suitable source. In some embodiments, hardware processor 212 can send and receive data through communications link 131 or any other communication links using, for example, a transmitter, a receiver, a transmitter/receiver, a transceiver, or any other suitable communication device. Input device 216 can be a computer keyboard, a mouse, a touchscreen, a microphone, and/or any other suitable input device. Display 214 can be a touchscreen, a flat-panel display, a cathode ray tube display, a projector, a speaker or speakers, and/or any other suitable display and/or presentation devices on which videos and/or animations can be presented.

Servers 121 and/or 123 can include a hardware processor 222, a display 224, an input device 226, and memory 228, which can be interconnected. In some embodiments, memory 228 can include a storage device for storing data received through communications link 141 or through other links, and can also receive commands and values transmitted by one or more users. The storage device can further include a server program for controlling hardware processor 222. For example, the server program can specify one or more techniques by which candidate media content items are to be identified, probability values indicating a likelihood that a message is associated with a particular media content item are calculated, and/or any other suitable techniques.

The mechanisms described herein for suggesting a link to media content can be implemented in user devices 111 and servers 121 and 123 as software, firmware, hardware, or any suitable combination thereof.

In some embodiments, the functions performed by servers 121 and/or 123 can be implemented in one server or can be distributed as any suitable number of servers. For example, multiple media content server(s) 121 and/or multiple data server(s) 123 can be implemented in various locations to increase reliability and/or increase the speed at which the server can communicate with user devices 111.

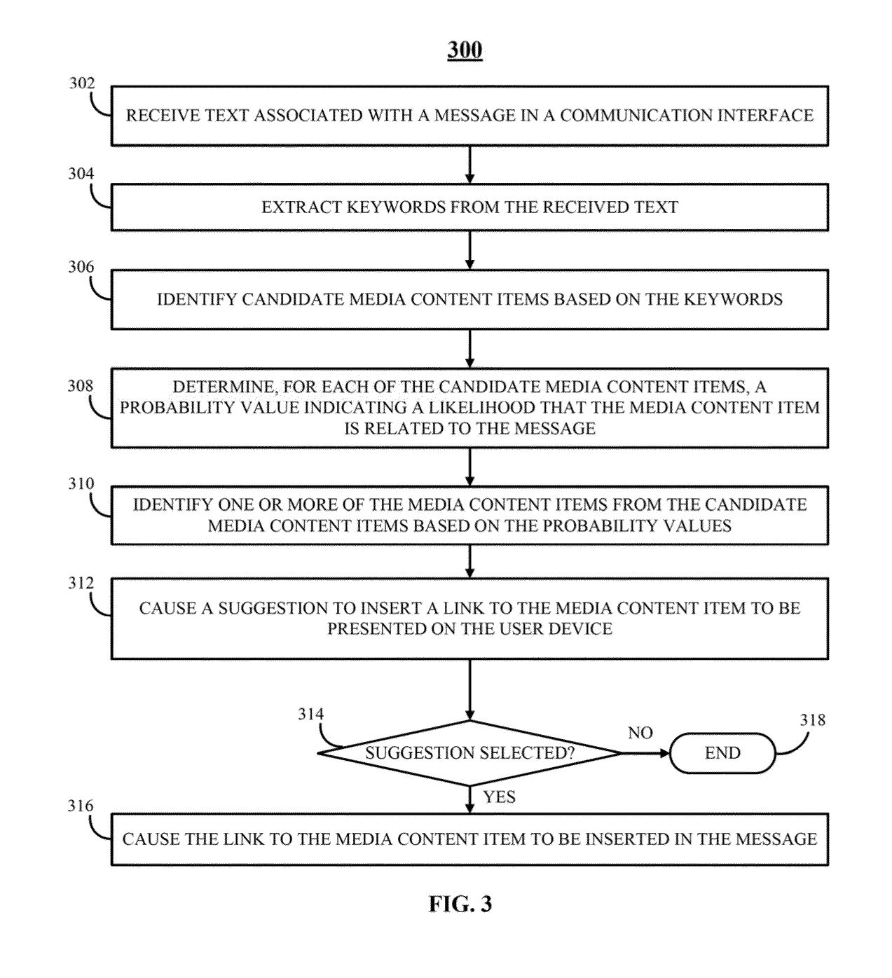

Turning to FIG. 3, an example 300 of a process for identifying a media content item related to a message in a communication interface of a user device is shown in accordance with some embodiments of the disclosed subject matter. Note that, in some embodiments, portions of process 300 can be executed on user device 111, server 121, and/or server 123.

Process 300 can begin by receiving text associated with a message in a communication interface at 302. In some embodiments, the message can include any suitable type of communication, such as a text message, an email, a chat and/or instant message, a comment on a post on a social networking site, and/or any other suitable type of message. In some embodiments, the message can include any other suitable content, such as images, icons, graphics, animations, and/or any other suitable content.

Process 300 can extract keywords from the received text at 304. In some embodiments, the keywords can include any suitable words, phrases, and/or numbers that might be related to media content. For example, media content related keywords can include a title of a media content item, such as a movie, a music, a TV program, an animation, and/or any suitable media content items. As another example, keywords can include a name of a person or a virtual character related to a media content item, such as a director of a movie, an actor in a movie, a composer of a music item, a name of a singer and/or a band, a character in a cartoon, a creator of a video stored on a video sharing site, and/or any other suitable name associated with a media content item. As yet another example, media content related keywords can include time information, such as a release period of a TV series, a premiere date of a movie, a broadcasting time of a program, a time associated with creation and/or an upload of a video to a video sharing site, an indication of a time relative to a current time (e.g., “new,” “recent,” “latest,” “old,” “two years ago,” “last week,” and/or any other suitable time), and/or any other suitable time period. As still another example, keywords can include any other suitable information related to media content, such as publisher information, price information, content information, review information, etc.

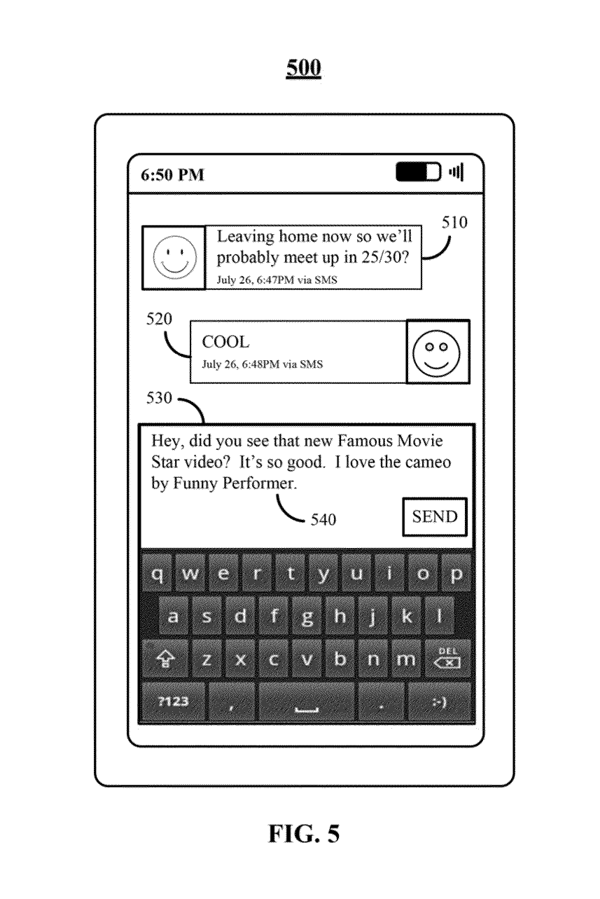

In a particular example, as illustrated in FIG. 5, current message content 540 in a message input 530 can be parsed to extract keywords such as names of artists and/or performers (e.g., “Famous Movie Star” and/or “Funny Performer”), information about the type of media content item referred to in message 530 (e.g., “video” and/or “cameo”), and/or information about timing information associated with the media content item (e.g., “new”).

Process 300 can extract the keywords using any suitable technique or combination of techniques. For example, in some embodiments, process 300 can access a list and/or a table of names associated with media content items (e.g., names of artists, performers, movies, television programs, and/or any other suitable names) and/or words or phrases associated with media content (e.g., “video,” “television,” “music,” “song,” “catchy,” and/or any other suitable words and/or phrases), and process 300 can determine if any words in the message correspond to a table entry. In some embodiments, the list and/or table can be updated based on new information. For example, in some embodiments, process 300 can use any suitable technique(s) (e.g., natural language processing techniques, Bayesian statistics, neural networks, any suitable machine learning techniques, and/or any other suitable techniques) to add words and/or phrases to the list or table. As a more particular example, in some embodiments, process 300 can use machine learning techniques to identify the name of a newly released video or other media content item based on occurrences of the video title or other information in parsed messages.

Note that the keywords can be extracted on any suitable device. For example, in some embodiments, the keywords can be extracted by the user device on which the message is entered. In some such embodiments, the keywords can be transmitted to a server, such as media content server 121 and/or data server 123. As another example, in some embodiments, the keywords can be extracted by media content server 121 and/or data server 123. In some such embodiments, any suitable portion of the message can be transmitted from the user device to the server. Additionally, in some embodiments, consent from the user to parse the text of the message can be requested and/or required.

Process 300 can identify candidate media content items based on the extracted keywords at 306 using any suitable technique or combination of techniques. For example, in some embodiments, process 300 can use any suitable search techniques to search a database of media content items using the extracted keywords as search terms. In some embodiments, process 300 can determine a category corresponding to each keyword, and can include information relating to the category in a search query. For example, if a keyword corresponds to a name of a particular television series, process 300 can determine that the associated category is “television series name,” and can include terms related to a television series (e.g., “episode,” “television,” and/or any other suitable terms) in the search query. As another example, if the keyword corresponds to a name of a particular television series, process 300 can determine information related to the particular television series (e.g., a name of a channel on which the series was broadcast, a name of an actor starring in the series, a name of a recent episode, and/or any other suitable information), and can include this information in the search query. As still another example, if a keyword corresponds to time information (e.g., “new,” “last year,” “recent,” “latest,” “last episode,” and/or any other suitable time information), process 300 can include the keyword and/or time information relating to the keyword (e.g., a range of dates, a particular date and/or time, and/or any other suitable information) in the search query. The group of candidate media content items identified by process 300 can include any suitable number (e.g., one, five, ten, twenty, fifty, and/or any other suitable number) of media content items.

Note that, in some embodiments, process 300 can identify the candidate media content items based on information associated with a user account (e.g., an account associated with a video sharing site, an account associated with a social networking site, and/or any other suitable site) associated with the user device on which the message is entered. For example, in some embodiments, the candidate media content items can include those that have previously been viewed in association with the user account. As another example, in some embodiments, the candidate media content items can include those that have been commented on in association with the user account. As yet another example, in some embodiments, the candidate media content items can include those that have been viewed and/or commented on within a particular time period (e.g., in the last week, in the last month, and/or any other suitable time period).

Process 300 can determine, for each of the candidate media content items, a probability value indicating a likelihood that the media content item is related to the message at 308. The probability value can be determined using any suitable information or combination of information. For example, in some embodiments, the probability value can be determined based on information such as how related metadata associated with the media content item is to one or more keywords, how popular the media content item is, how recently and/or how many times the media content item has been viewed in association with a user account authenticated on the user device, and/or any other suitable information.

For example, in some embodiments, process 300 can determine the probability value based on how relevant the media content item is to one or more of the keywords based on metadata associated with the media content item. As a more particular example, in some embodiments, process 300 can determine whether there is an exact match between any of the keywords and metadata (e.g., a name of a particular actor is included in both the keywords and the metadata, and/or any other suitable type of match). As another more particular example, in some embodiments, process 300 can determine whether a keyword is related to the metadata if there is no exact match by determining how often the keyword appears with the metadata in a search (e.g., a search of web sites, a search a media content database, and/or any other suitable search).

As another example, in some embodiments, process 300 can determine the probability value based on information indicating how popular the media content item is. As a more particular example, process 300 can determine how popular the media content item is based on how many times the media content item has been viewed (e.g., a total number of views, a number of views per day, a number of views in a recent time period, and/or any other suitable metric), how many times the media content item has been commented on, how many times the media content item has been shared in social networking posts, and/or any other suitable information indicating popularity.

As yet another example, in some embodiments, process 300 can determine the probability value based on how related one or more keywords are to comments associated with the media content item. For example, in instances where the extracted keywords include descriptions of a media content item (e.g., “funny,” “hilarious,” “catchy,” and/or any other suitable words and/or phrases), process 300 can determine the probability value based on how often the descriptions and/or related words occur in comments associated with the media content item.

Process 300 can calculate the probability value using any suitable technique or combination of techniques. For example, in some embodiments, process 300 can calculate a score associated with each of multiple factors (e.g., how relevant metadata associated with the media content item is to one or more keywords, how popular the media content item is, how many times the media content item has been viewed in association with a user account authenticated on the user device, and/or any other suitable factors), and can calculate the probability value by combining the scores corresponding to each factor. In some embodiments, the probability value can be a weighted combination of the scores. For example, in some embodiments, how popular the media content item is can be weighted more heavily than how many times the media content item has been viewed in association with the user account. In some embodiments, process 300 can update the weights associated with each score using any suitable information. For example, process 300 can update the weights in response to determining that a link suggested at block 312 of process 300 based on the current weights was not selected.

Process 300 can identify one or more of the media content items from the candidate media content items based on the probability values at 310. Process 300 can identify any suitable number (e.g., one, two, five, ten, and/or any other suitable number) of media content items. For example, in instances where process 300 presents suggestions to link to multiple media content items, thereby allowing the user to select one of the suggestions for inclusion in the message, process 300 can select multiple (e.g., two, five, ten, and/or any other suitable number) media content items. In some embodiments, process 300 can determine the number of media content items (N) to identify, and can identify the N media content items with the highest probability values. In some embodiments, process 300 can determine the number of media content items to identify based on any suitable information, such as a type of device (e.g., a mobile device, a desktop computer, a laptop computer, a wearable computer, and/or any other suitable type of user device) on which the message is entered, a screen size associated with the device, and/or any other suitable information. As a more particular example, in some embodiments, process 300 can determine that suggestions of multiple media content items are to be presented in response to determining that the user device is a device with a relatively large screen size, such as a desktop computer or laptop computer. Conversely, in some embodiments, process 300 can determine that a single suggestion of a like to a media content item is to be presented in response to determining that the user device is a device with a relatively small screen size, such as a mobile phone.

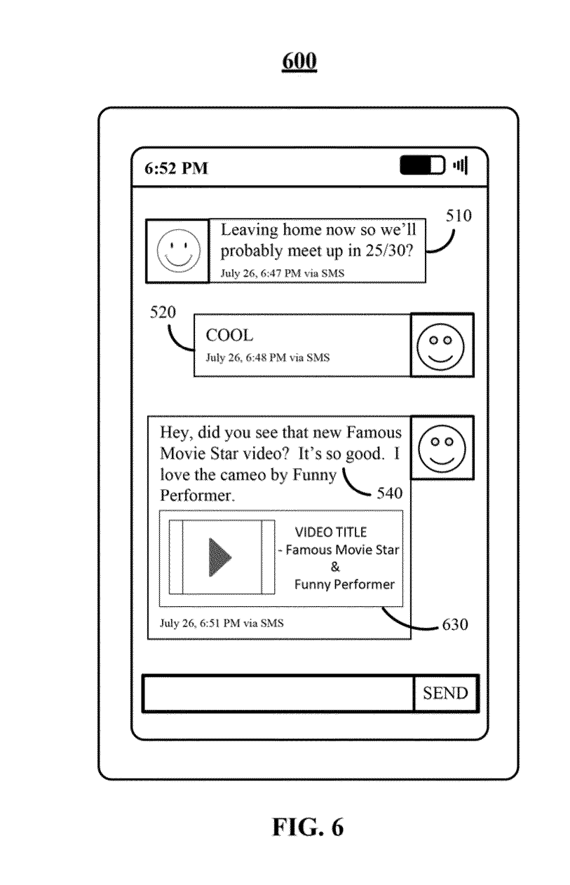

Process 300 can cause a suggestion to insert a link to the media content item(s) to be presented on the user device at 312. As shown in and described below in connection with FIG. 6, in some embodiments, the suggestion can include a link to one media content item (e.g., the media content item associated with the highest probability value, and/or any other suitable media content item). Additionally or alternatively, in some embodiments, process 300 can cause a group of suggestions, each with a link to a different media content item, to be presented, thereby allowing a user to select which link to insert in the message. As shown in and described in connection with FIG. 6, the suggestion can include any suitable content, such as an image (e.g., a thumbnail associated with the media content item, and/or any other suitable image), text (e.g., text describing the media content item, and/or any other suitable text), animations, icons, graphics, and/or any other suitable content.

In some embodiments, the suggestion(s) can be presented in a selectable suggestion interface. In such embodiments, process 300 can determine if the suggestion and/or suggestion interface has been selected at 314 using any suitable technique(s). For example, in some embodiments, the user device on which the suggestion and/or suggestion interface is presented can determine if the suggestion and/or suggestion interface was clicked and/or touched (e.g., on a touchscreen). Additionally or alternatively, in some embodiments, process 300 can determine that the suggestion was not selected by determining that the suggestion and/or the suggestion interface was dismissed and/or swiped off a touchscreen. Note that, in some embodiments, block 314 can be omitted, and process 300 can automatically insert a link to a selected media content item into the message.

If, at 314, it is determined that the suggestion and/or suggestion interface was selected (“yes” at 314), process 300 can cause the link to the media content item to be inserted in the message at 316. For example, in some embodiments, the link can be inserted in any suitable manner. For example, in some embodiments, one or more keywords in the message can be hyperlinked to a location of the media content item (e.g., on a video sharing website, and/or to any other suitable location). Additionally or alternatively, in some embodiments, the link can be inserted at the end of the message text. In some embodiments, the link can include any suitable content, such as text, images, icons, graphics, and/or any other suitable content.

If, at 314, it is determined that the suggestion and/or suggestion interface were not selected (“no” at 314), process 300 can terminate at 318.

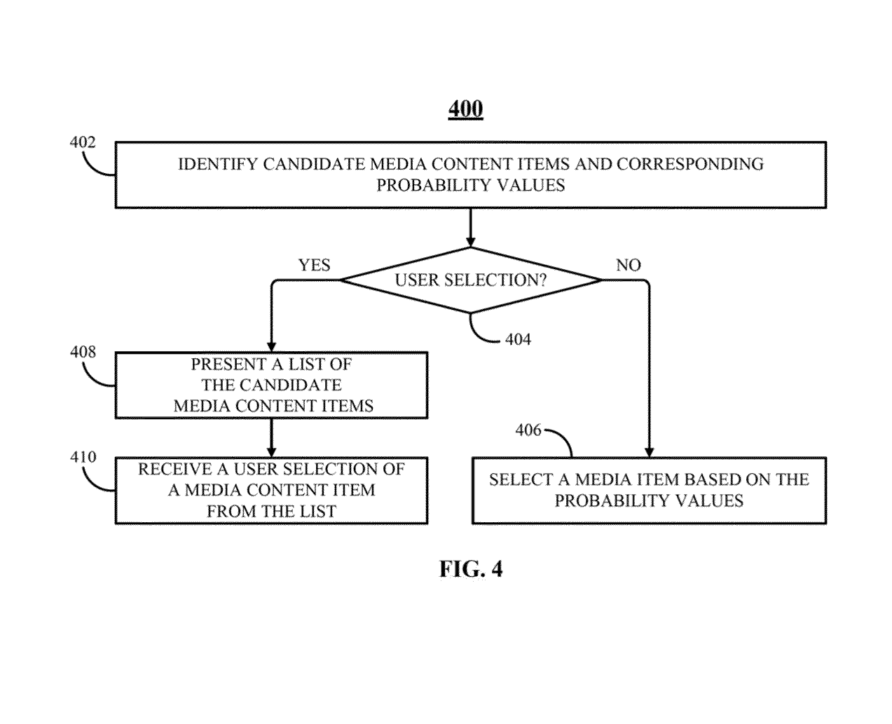

Turning to FIG. 4, an example 400 of a process for identifying a selection of a media content item from a group of candidate media content items, either based on user selection, or selected based on probability value, is shown in accordance with some embodiments of the disclosed subject matter.

Process 400 can begin by identifying candidate media content items and their corresponding probability values at 402. In some embodiments, process 400 can receive this information from process 300, for example, from probability values calculated at block 308 of FIG. 3.

Process 400 can determine whether the selected media content item is to be selected based on user input at 404 using any suitable information and/or technique(s). For example, in some embodiments, process 400 can determine that the media content item is to be selected via user selection if suggestions of links to multiple media content items are presented. Conversely, process 400 can determine that user selection of a particular media content item from the group of candidate media content items is not needed if only one suggestion is presented, as described above in connection with block 310 of FIG. 3.

If, at 404, it is determined that no user selection is needed (“no” at 404), process 400 can select a particular media content item from the group of candidate media content items based on the probability values associated with each of the candidate media content items at 406. For example, in some embodiments, process 400 can select the media content item with the highest probability value.

If, at 404, it is determined that the particular media content item is to be selected via user selection (“yes” at 404), process 400 can present a list of the candidate media content items and/or any suitable subset of the candidate media content items at 408. For example, in some embodiments, a suggestion interface including any suitable number (e.g., two, three, five, ten, and/or any other suitable number) of candidate media content items can be presented. In some embodiments, the list of candidate media content items can be ordered based on any suitable information. For example, in some embodiments, the list of candidate media content items can be ordered based on their respective probability values (e.g., highest to lowest, and/or any other suitable ordering). As described above in connection with block 312 of FIG. 3, each suggestion can include any suitable content, such as text, images, icons, links, and/or any other suitable content.

Process 400 can receive a user selection of a particular media content item from the presented list at 410. As described above in connection with block 314 of FIG. 3, the list of media content items can be presented in a suggestion interface, portions of which can be selectable. In some embodiments, process 400 can determine that a particular media content item presented in the suggestion interface was indicated by determining that the corresponding media content item was clicked, touched, and/or indicated in any other suitable manner.

Turning to FIG. 5, an example 500 of a user interface including a message and a communication interface is presented in accordance with some embodiments of the disclosed subject matter. As illustrated, user interface 500 can include sent and/or received messages, such as messages 510 and 520, a message input 530, and current message content 540.

Messages 510 and 520 can be any suitable messages, such as text messages, emails, chat and/or instant messages, comments and/or posts on a social networking site, and/or any other suitable type of message. Messages 510 and 520 can include any suitable content, such as text, images, icons, graphics, links, videos, animations, and/or any other suitable content. Although only two sent and/or received messages are shown in FIG. 5, in some embodiments, any suitable number (e.g., zero, one, five, ten, twenty, and/or any other suitable number) can be included.

Message input 530 can be any suitable user interface for receiving text input from a user device. For example, as shown in FIG. 5, message input 530 can include an input window with a touchscreen keyboard displayed. As another example, in some embodiments, message input 530 can include a window for entering contents of an email, a user interface for entering comments and/or posts on a social networking site, and/or any other suitable user interface.

Current message content 540 can include any suitable message contents for a message that is currently being entered (e.g., prior to sending and/or entering). As described above, current message content 540 can include any suitable content, such as text, images, icons, graphics, animations, links, and/or any other suitable content. Additionally, as described above in connection with block 304 of FIG. 3, current message content can be parsed to extract keywords included in the message.

Turning to FIG. 6, an example 600 of a user interface for inserting a link in a message is shown in accordance with some embodiments of the disclosed subject matter. As illustrated, user interface 600 can include a link to media content 630.

Link to media content 630 can include a link to a particular media content item on any suitable site (e.g., a video sharing site, a social networking site, and/or any other suitable site). As shown in FIG. 6, link to media content 630 can be inserted in current message content 540. Additionally, as described above in connection with block 316 of FIG. 3, the link can include any suitable content, such as text (e.g., indicating a title of the media content item, indicating content of the media content item, and/or indicating any other suitable information), images (e.g., thumbnail captured from the media content item and/or otherwise associated with the media content item), graphics, icons, animations, and/or any other suitable content.

In some embodiments, the application can include client-side software, server-side software, hardware, firmware, or any suitable combination thereof. For example, the application can encompass a computer program that causes one or more processors to execute the content generation application. As another example, the application(s) can encompass a computer program written in a programming language recognizable by user device(s) 111 and/or server(s) 121 that is executing the application(s) (e.g., a program written in a programming language, such as, Java, C, Objective-C, C++, C#, Javascript, Visual Basic, HTML, XML, ColdFusion, any other suitable approaches, or any suitable combination thereof). In some embodiments, the application can encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, and/or any other suitable media), optical media (such as compact discs, digital video discs, Blu-ray discs, and/or any other suitable optical media), semiconductor media (such as flash memory, electrically programmable read only memory (EPROM), electrically erasable programmable read only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be noted that the above steps of the flow diagrams of FIGS. 3 and 4 can be executed or performed in any suitable order or sequence not limited to the order and sequence shown and described in the figures. Also, some of the above steps of the flow diagrams of FIGS. 3 and 4 can be executed or performed substantially simultaneously where appropriate or in parallel to reduce latency and processing times. Furthermore, it should be noted that FIGS. 3 and 4 are provided as examples only. At least some of the steps shown in the figures may be performed in a different order than represented, performed concurrently, or altogether omitted.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

In situations in which the systems described here collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for suggesting a link to media content are provided.

Although the disclosed subject matter has been described and illustrated in the foregoing illustrative embodiments, it is understood that the present disclosure has been made only by way of example, and that numerous changes in the details of embodiments of the disclosed subject matter can be made without departing from the spirit and scope of the disclosed subject matter, which is limited only by the claims that follow. Features of the disclosed embodiments can be combined and rearranged in various ways.

What is claimed is:

1. A method for suggesting a link to media content, the method comprising:
identifying a plurality of keywords in a message in a communication interface on a user device;
determining a plurality of media content items relating to the plurality of keywords;
determining, using a hardware processor, a plurality of probability values corresponding to the plurality of media content items, wherein each probability value indicates a likelihood that the message relates to the corresponding media content item;
identifying one of the media content items based on the probability values;
causing a suggestion to insert a link to the identified media content item to be presented in a suggestion interface on the user device; and
in response to determining that the suggestion has been selected on the user device, causing the link to the identified media content item to be inserted in the message in the communication interface.

2. The method of claim 1, wherein the plurality of keywords include an indication of a name of an artist, and wherein the plurality of media content items includes one or more media content items associated with the artist.

3. The method of claim 1, wherein the plurality of keywords includes an indication of time, and wherein the plurality of media content items includes one or more media content items corresponding to the indicated time.

4. The method of claim 1, wherein determining the plurality of media content items further comprises identifying one or more media content items associated with a user account authenticated on the user device.

5. The method of claim 1, wherein the plurality of probability values are based at least in part on popularity information associated with the corresponding plurality of media content items.

6. The method of claim 1, wherein the plurality of probability values are based at least in part on comments associated with the corresponding plurality of media content items.

7. The method of claim 1, wherein the suggestion interface includes an image associated with the identified media content item.

8. A system for suggesting a link to media content, the system comprising:
a hardware processor that is programmed to:
identify a plurality of keywords in a message in a communication interface on a user device;
determine a plurality of media content items relating to the plurality of keywords;
determine a plurality of probability values corresponding to the plurality of media content items, wherein each probability value indicates a likelihood that the message relates to the corresponding media content item;
identify one of the media content items based on the probability values;
cause a suggestion to insert a link to the identified media content item to be presented in a suggestion interface on the user device; and
in response to determining that the suggestion has been selected on the user device, cause the link to the identified media content item to be inserted in the message in the communication interface.

9. The system of claim 8, wherein the plurality of keywords include an indication of a name of an artist, and wherein the plurality of media content items includes one or more media content items associated with the artist.

10. The system of claim 8, wherein the plurality of keywords includes an indication of time, and wherein the plurality of media content items includes one or more media content items corresponding to the indicated time.

11. The system of claim 8, wherein the hardware processor is further programmed to identify one or more media content items associated with a user account authenticated on the user device.

12. The system of claim 8, wherein the plurality of probability values are based at least in part on popularity information associated with the corresponding plurality of media content items.

13. The system of claim 8, wherein the plurality of probability values are based at least in part on comments associated with the corresponding plurality of media content items.

14. The system of claim 8, wherein the suggestion interface includes an image associated with the identified media content item.

15. A non-transitory computer-readable medium containing computer executable instructions that, when executed by a processor, cause the processor to perform a method for suggesting a link to media content, the method comprising:
identifying a plurality of keywords in a message in a communication interface on a user device;
determining a plurality of media content items relating to the plurality of keywords;
determining a plurality of probability values corresponding to the plurality of media content items, wherein each probability value indicates a likelihood that the message relates to the corresponding media content item;
identifying one of the media content items based on the probability values;
causing a suggestion to insert a link to the identified media content item to be presented in a suggestion interface on the user device; and
in response to determining that the suggestion has been selected on the user device, causing the link to the identified media content item to be inserted in the message in the communication interface.

16. The non-transitory computer-readable medium of claim 15, wherein the plurality of keywords include an indication of a name of an artist, and wherein the plurality of media content items includes one or more media content items associated with the artist.

17. The non-transitory computer-readable medium of claim 15, wherein the plurality of keywords includes an indication of time, and wherein the plurality of media content items includes one or more media content items corresponding to the indicated time.

18. The non-transitory computer-readable medium of claim 15, wherein determining the plurality of media content items further comprises identifying one or more media content items associated with a user account authenticated on the user device.

19. The non-transitory computer-readable medium of claim 15, wherein the plurality of probability values are based at least in part on popularity information associated with the corresponding plurality of media content items.

20. The non-transitory computer-readable medium of claim 15, wherein the plurality of probability values are based at least in part on comments associated with the corresponding plurality of media content items.

21. The non-transitory computer-readable medium of claim 15, wherein the suggestion interface includes an image associated with the identified media content item.
